(19) United States
(12) Patent Application Publication
(10) Pub. No.: US 2005/0091262 A1
(43) Pub. Date: Apr. 28, 2005

(54) Method, apparatus, and program for finding and navigating to items in a set of web pages

(76) Inventor: Tai Anh Cao, Austin, TX (US)

Correspondence Address: IBM CORP (YA);C/O YEE & ASSOCIATES PC, P.O. BOX 802333, DALLAS, TX, 75380, US

(21) Appl. No.: 10/988,079

(22) Filed: Nov. 12, 2004

Related U.S. Application Data
(62) Division of application No. 09/974,989, filed on Oct. 11, 2001.

(51) Int. Cl. G06F 7/00

(52) U.S. Cl. 707/102

(57) ABSTRACT

A mechanism is provided for highlighting items of interest in a set of web pages. The link highlighting mechanism may retrieve and examine web pages referenced by the instant web page. In this manner, the link highlighting mechanism may crawl through a set of web pages and highlight links that direct the user to the item of interest. The link highlighting mechanism may also record a user's click sequence to determine the most recently or most frequently visited links. The mechanism may then highlight the most recently or most frequently visited links to allow easy and quick navigation to items that are of particular interest to the user. The user may also enter properties of an item of interest, such as a file type or link type. The link highlighting mechanism examines a web page for items and links that match the property. If the user is using a mobile computing device or is otherwise operating with limited bandwidth, the highlighting mechanism may reside on a server. Thus, the server may transmit only the item of interest unless otherwise instructed by the user.

### CROSS REFERENCE TO RELATED APPLICATIONS

The present application is related to co-pending U.S. patent application Ser. No. 09/697,444 (IBM Docket No. AUS9-2000-0558-US1) entitled “METHOD OF INDICATING CHANGED LINKS TO EASE THE USE OF FREQUENTLY USED WEB PAGES” filed 26 Oct. 2000. The content of the above mentioned commonly assigned, co-pending U.S. Patent application is hereby incorporated herein by reference for all purposes.

### BACKGROUND OF THE INVENTION

1. Technical Field:

The present invention relates to an improved data processing system and, in particular, to a method and apparatus for managing world wide web documents in a data processing system. Still more particularly, the present invention provides a method, apparatus, and program for finding and navigating to items in a set of web pages.

2. Description of Related Art:

As web pages become more sophisticated, with various typefaces and images, and contain more content, it becomes more difficult to locate items of interest. With web sites that are visited regularly, users may develop a pattern of usage. For example, some content providers have start pages with large amounts of content, such as news and search engines, customized for individual users. Such a page is typically referred to as a “portal.” A user may visit the portal to check the weather every day, for example. However, it may be difficult to locate a hyperlink to the weather in a page with a large amount of content and, particularly, a page with many hyperlinks. Hyperlinks are also referred to as “links.”

Furthermore a user may be using a handheld computing device to navigate the page. Thus, the user is operating with a limited screen size and resolution. If the user is operating with limited time to locate items of interest, the process of navigating a web page becomes very difficult and even frustrating. In fact, navigation of any interface may become cumbersome if screen space or time are limited, particularly when a plurality of layers of interface are routinely traversed.

Typically, mobile devices also operate with limited bandwidth. Therefore, mobile devices, such as handheld and notebook computers, require significant time to download a web page. Consequently, when a user frequently traverses the same sequence of links in a series of web pages, the process of repeatedly downloading each page and locating and selecting links becomes tedious.

Furthermore, a user may wish to locate a link to a particular image or sound file. However, it may be difficult to distinguish the desired link from other links in the page without reading each link and the surrounding text. Particularly, a user may have difficulty finding a specific item of interest while performing other tasks. For example, a user may be using a handheld or palmtop computer in a meeting or sitting at a red light. As stated above, locating links with a palmtop computer may also be difficult due to the small screen size, low resolution, and low bandwidth. When a typical page is displayed on a palmtop computer, the text size may be too small to read easily and/or the page size may be too large to display without scrolling.

Therefore, it would be advantageous to provide an improved mechanism for finding and navigating to items of interest in a set of web pages.

### SUMMARY OF THE INVENTION

The present invention provides a mechanism for highlighting items of interest in an interface, such as a web page. The highlighting mechanism may retrieve and examine web pages referenced by the instant web page. In this manner, the link highlighting mechanism may crawl through a set of web pages and highlight links that direct the user to the item of interest. The link highlighting mechanism may also record a user's click sequence to determine the most recently or most frequently visited links or items. The mechanism may then highlight the most recently or most frequently visited links or items to allow easy and quick navigation to items that are of particular interest to the user. The user may enter properties of an item of interest, such as a file type or link type. For example, a user may be looking for an image, sound, or e-mail address. The highlighting mechanism of the present invention then examines a web page or interface for items and links that match the property. If the user is using a mobile computing device or is otherwise operating with limited bandwidth, the highlighting mechanism may reside on a server. Thus, the server may transmit only the item of interest unless otherwise instructed by the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A-4C and 5A-5F are examples of screens of display of a web browser window in accordance with a preferred embodiment of the present invention;

FIG. 6 is an example document hierarchy in accordance with a preferred embodiment of the present invention;

FIGS. 7A and 7B are block diagrams illustrating example network arrangements in accordance with a preferred embodiment of the present invention;

FIG. 8 is a block diagram of a browser program in accordance with a preferred embodiment of the present invention;

FIGS. 9A-9C are flowcharts illustrating a process of highlighting recently used and frequently used links in accordance with a preferred embodiment of the present invention; and

FIG. 10 is a flowchart illustrating a process of highlighting items of interest in accordance with a preferred embodiment of the present invention.

### DETAILED DESCRIPTION OF THE PREFERRED EMBODIMENT

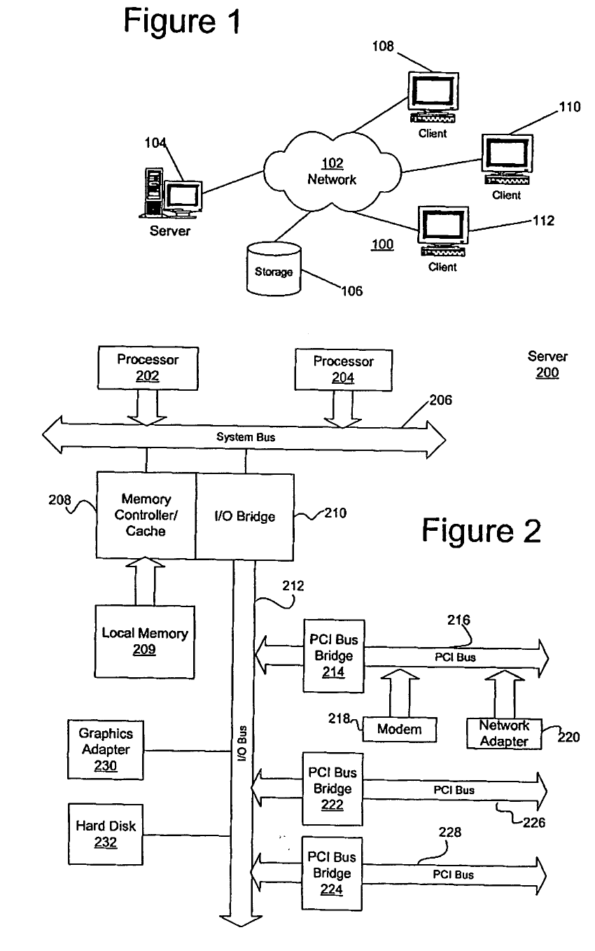

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as web content, to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

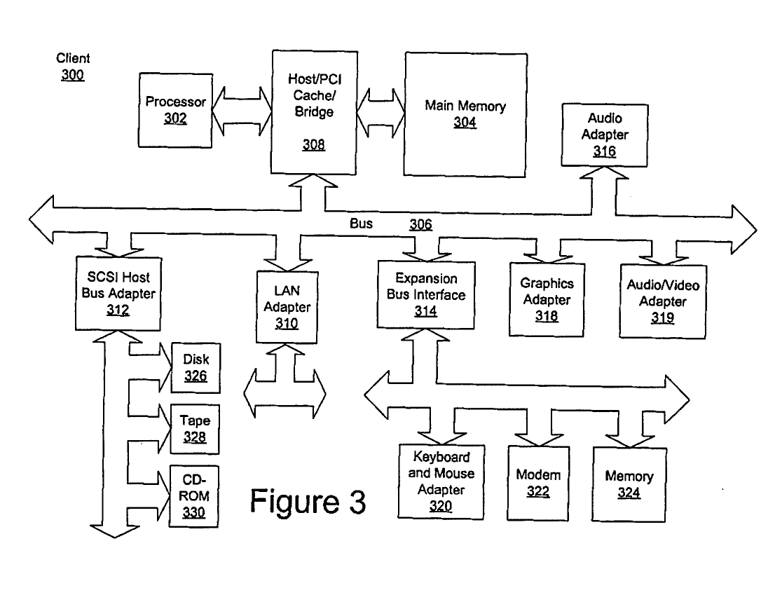

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

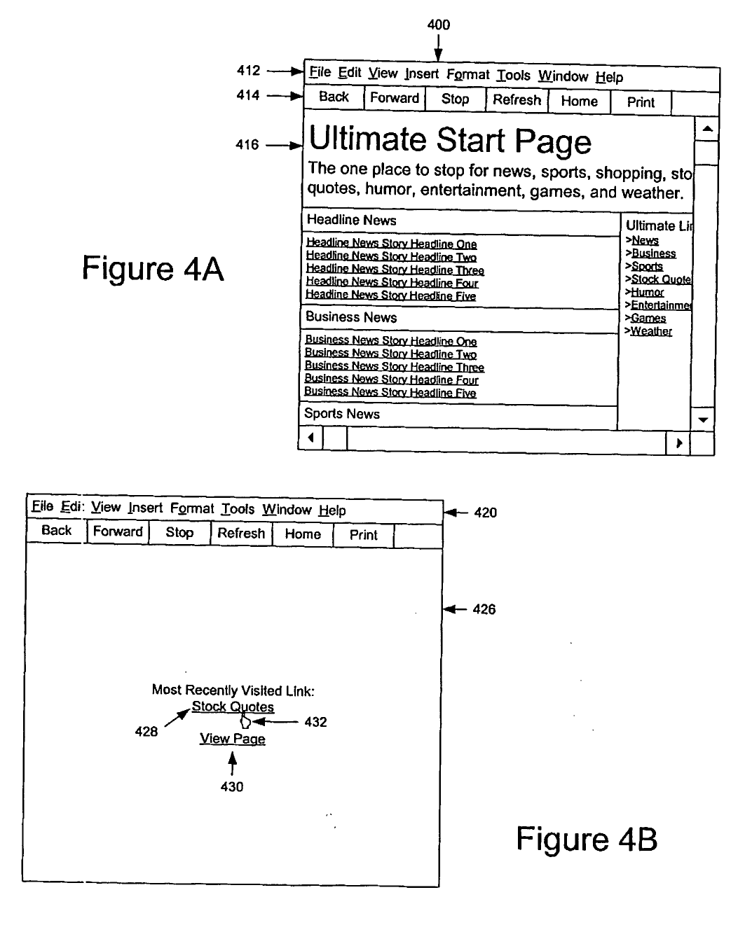

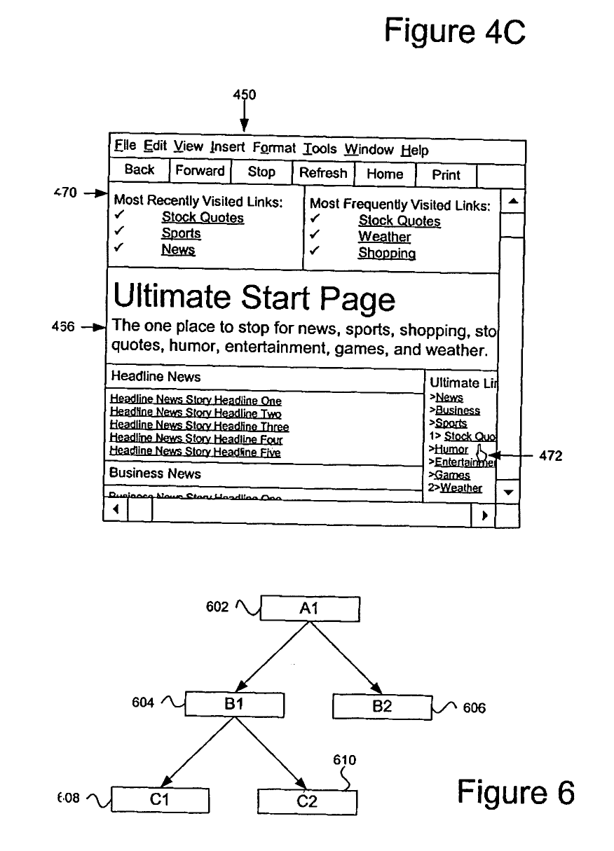

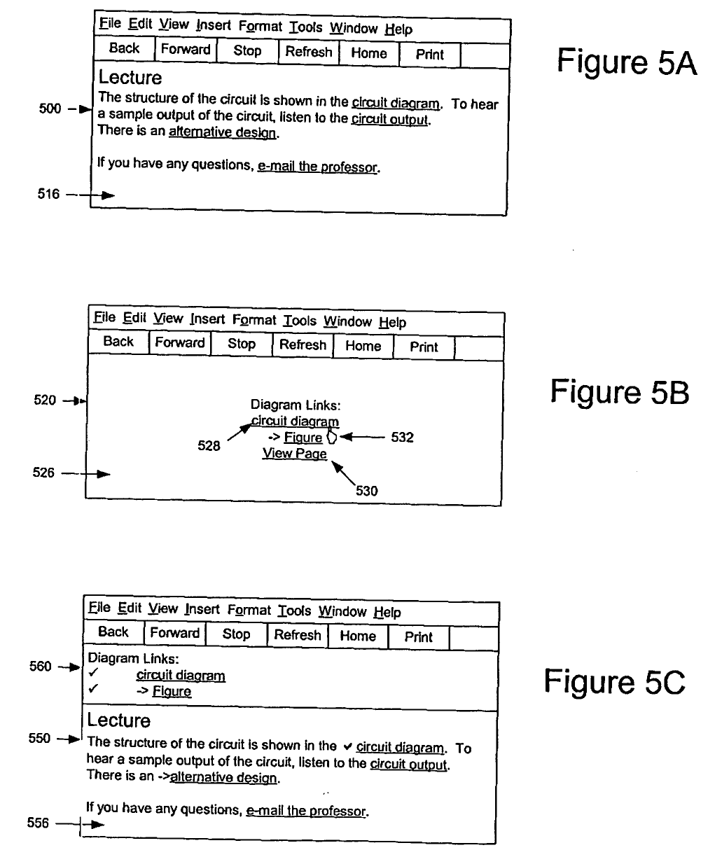

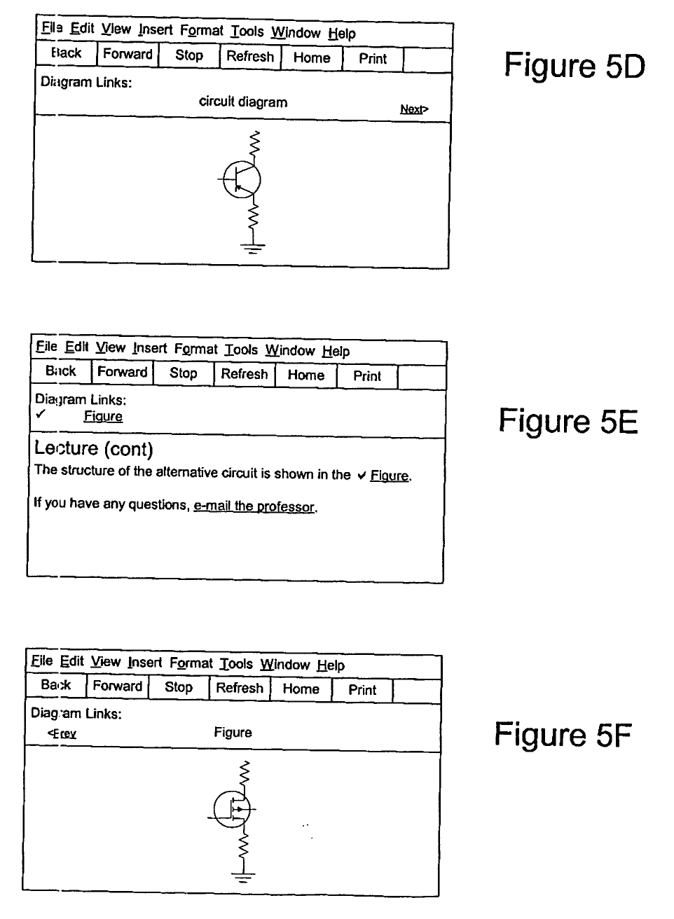

Examples of screens of display of a web browser window are shown in FIGS. 4A-4C and 5A-5C in accordance with a preferred embodiment of the present invention. Particularly with respect to FIG. 4A, an example screen of display is shown in which an item of interest may be found in a sophisticated web page with many links. A screen comprises window 400, including menu bar 412. Menus to be selected from menu bar 412 may include “File,” “Edit,” “View,” “Insert,” “Format,” “Tools,” “Window,” and “Help.” However, menu bar 412 may include fewer or more menus, as understood by a person of ordinary skill in the art. The browser window also includes button toolbar 414, which provides buttons for navigation and management of web pages. the button toolbar includes “Back,” “Forward,” “Stop,” “Refresh,” “Home,” and “Print” buttons. However, button toolbar 414 may include fewer or more buttons, as understood by a person of ordinary skill in the art.

Browser window 400 includes web page 416, which is an example of a portal or start page. Such a page typically contains a large amount of content, including links. For example, a typical portal may contain links to headline news stories, business stories, sports stories, stock quotes, weather, games, shopping, etc. In this example, a user may visit the “Stock Quotes” link frequently and may wish to locate and select this link quickly.

Users may bookmark pages that are visited frequently or recently. When traveling the hierarchy of pages to arrive at a frequently or recently used page, one is guaranteed that the web pages are still part of the hierarchy and they are of the latest version. When visiting a bookmarked page, a user may not have the benefit of traveling the hierarchy to determine what is added, removed, rearranged, etc. A bookmarked page may not be up-to-date or may be dropped from the hierarchy and replaced with another page.

In accordance with a preferred embodiment of the present invention, the link highlighting mechanism records a user's click sequence to determine the most recently or most frequently visited links. The link highlighting mechanism may reside on a server, such as a proxy server. The server may receive a request for a page and determine the most recently or most frequently used link. This may be accomplished by recording the user's click sequence, as stated above. For example, the first time a user visits web page 416, the user may visit the “Stock Quotes” link. The link highlighting mechanism then may record this item as the “recently used” link.

Turning to FIG. 4B, an example screen of display is shown in which the recently used link is presented first. A user requests a web page and the link highlighting mechanism determines that the “Stock Quotes” link is the most recently used link, as described above. Browser window 420 displays web page 426, wherein the most recently used link 428 is displayed. Web page 426 also includes “View Page” link 430 that may be selected to retrieve the whole page for viewing. In the example shown in FIG. 4B, the link highlighting mechanism may reside on a server, such as a proxy server. The server may then transmit web page 426 rather than page 416 shown in FIG. 4A, thus allowing the user to quickly and conveniently navigate to the most recently used link without downloading and analyzing the entire page.

Cursor 432 may be automatically placed over the “Stock Quotes” link allowing the user to quickly select the link without repositioning the cursor. When a user routinely traverses a series of pages, the highlighting mechanism of the present invention allows the user to iteratively select the most recently used or most frequently used link by pressing a single button, clicking a mouse button, or tapping the screen with a stylus. The link highlighting mechanism may also employ gravity clicking, enabling the user to click any area surrounding the item of interest to select the item.

The link highlighting mechanism may also record the three most recently used links. Similarly, the click sequence may include a predetermined number of visited links, such as a click sequence of twenty links for example. The link highlighting mechanism may then determine the most frequently used link from the click sequence.

With reference now to FIG. 4C, an example screen of display is shown in which the recently used link is highlighted. Browser window 450 displays web page 466. The link highlighting mechanism determines that the “Stock Quotes” link is the recently used link and highlights that link the web page 466 with graphical indicator, such as a check mark. The highlighting mechanism also determines a second and third most recently used link and the three most frequently used links.

Browser window 450 may also include portion 470 displaying the items of interest at the top of the page. Portion 470 may be added to web page 466. In an alternative embodiment, portion 470 and web page 466 may be displayed in separate frames. The link highlighting mechanism may rank the most recently used links and the most frequently used links in portion 470. The link highlighting mechanism may also show the difference between them in web page 466. For example, most recently used links and most frequently used links may be differentiated using different graphical indicators or colors. Furthermore, the most recently used links and/or the most frequently used links may be ranked using different graphical indicators or colors.

Furthermore, the link highlighting mechanism may scroll web page 466 so that the link is in a convenient location for selection, such as the top or center of the display. The link highlighting mechanism may also automatically relocate the cursor to the item of interest. For example, in FIG. 4B, cursor 472 is automatically placed over the “Stock Quotes” link. The link highlighting mechanism may also employ gravity clicking, enabling the user to click any area surrounding the item of interest to select the item.

The web page may be modified by a component of the browser program itself. In an alternate embodiment, the web page may be modified by a separate software component, such as a proxy server or web intermediary (WBI). Such a proxy server or web intermediary may exist on a server computer or in the client.

The web page shown in FIG. 4C may be displayed by default or may be displayed in response to the user selecting “View Page” link 430 in FIG. 4B. Whether the whole page is displayed initially or in response to explicit selection by the user may be defined in user preferences. Furthermore, whether the most recently or most frequently used link is displayed at the top of the page, whether the link is highlighted, whether the screen is automatically scrolled, whether the cursor is automatically positioned, and whether gravity clicking is used may also be set as user preferences.

With reference now to FIG. 5A, browser window 500 includes display area 516 that displays a web page. The web page includes three links. The first link is to “circuit diagram,” the second link is to “circuit output,” and the third link is to “e-mail the professor.” A user may wish to locate a link to a particular item in the web page. However, the user may not have the time to read the context of the links or to locate the links and reposition the cursor to select the desired item. For example, the user may wish to locate a link to a diagram. However, in the example shown in FIG. 5A, the user must locate the links, read the link text, identify the desired link, and reposition the cursor to select the desired link.

In accordance with a preferred embodiment of the present invention, a link highlighting mechanism is provided for finding and navigating to items of interest. The user may enter properties of an item of interest, such as a file type or link type, into a user interface (not shown). For example, a user may be looking for an image, sound, or e-mail address. The link highlighting mechanism of the present invention examines a web page for items and links that match the property. The link highlighting mechanism may also retrieve and examine web pages referenced by the instant web page. In this manner, the link highlighting mechanism may crawl through a set of web pages and highlight links that direct the user to the item of interest.

Turning to FIG. 5B, an example screen of display is shown with image file links displayed first. A user requests a web page and indicates an item of interest. In this example, the item of interest is any link to a file with an image file type or extension, such as “jpg” or “gif.” The link highlighting mechanism locates the image links, as requested by the user. Browser window 520 displays web page 526, wherein the items of interest 528 are displayed. Web page 526 also includes “View Page” link 530 that may be selected to retrieve the whole page for viewing. In the example shown in FIG. 5B, the link highlighting mechanism may reside on a server, such as a proxy server. The server may then transmit web page 526 rather than page 516 shown in FIG. 5A, thus allowing the user to quickly and conveniently navigate to the item of interest without downloading and analyzing the entire page.

Cursor 532 may be automatically placed over the “circuit diagram” link allowing the user to quickly select the link without repositioning the cursor. When a user wishes to navigate to a specific item of interest, the highlighting mechanism of the present invention allows the user to quickly select the item of interest by pressing a single button, clicking a mouse button, or tapping the screen with a stylus. The link highlighting mechanism may also employ gravity clicking, enabling the user to click any area surrounding the item of interest to select the item.

Turning to FIG. 5C, an example screen of display is shown with image file links highlighted. Browser window 550 displays web page 556. In this example, the link to “circuit diagram” is a link to a file with an image file type or extension, such as “jpg” or “gif.” The link highlighting mechanism locates the image link, as requested by the user, and highlights the item with a graphical indicator, such as a check mark. Other forms of highlighting may also be used, such as icons and color highlighting. For example, an camera icon may be used to indicate an image while a speaker icon may be used to indicate a sound file.

Furthermore, the link to “alternative design” is a link to an intermediate page that includes a link to a file with an image file type or extension, as indicated by the “−>” indicator. The user may then traverse the pages in the hierarchy to arrive at an item of interest by following the indicator. Other indicators may be used as known in the art.

Browser window 550 may also include portion 560 displaying the items of interest at the top of the page. Portion 560 may be added to web page 556. In an alternative embodiment, portion 560 and web page 556 may be displayed in separate frames.

The web page shown in FIG. 5C may be displayed by default or may be displayed in response to the user selecting “View Page” link 530 in FIG. 5B. Whether the whole page is displayed initially or in response to explicit selection by the user may be defined in user preferences. Furthermore, whether the link to the item of interest is displayed at the top of the page, whether the link is highlighted, whether the screen is automatically scrolled, whether the cursor is automatically positioned, and whether gravity clicking is enabled may also be set as user preferences.

FIGS. 5D-5F are example screens of display that illustrate pages including items of interest. Particularly, FIG. 5D shows a page resulting from selection of the circuit diagram link, such as link 528 in FIG. 5B. The page may include a navigation portion that displays a “Next” link. If the “Next” link is selected, the user will travel to the next item of interest.

FIG. 5E shows a page resulting from selection of an intermediate page. For example, the screen shown in FIG. 5E may result from selecting the “−>Figure” link in FIG. 5B or the “−>alternative design” link in FIG. 5C. The link highlighting mechanism then highlights the items of interest in the page shown in FIG. 5E. Alternatively, selection of the “Next” link shown in FIG. 5D may include intermediate pages and selection of the “Next” link may result in the page shown in FIG. 5E.

FIG. 5F shows a page resulting from the “Figure” link in FIG. 5E. The page may include a navigation portion that displays a “Prev” link. If the “Pext” link is selected, the user will travel to the previous item of interest. Alternatively, selection of the “Prev” link shown in FIG. 5F may include intermediate pages and selection of the “Prev” link may result in the page shown in FIG. 5E.

With reference to FIG. 6, an example document hierarchy is shown in accordance with a preferred embodiment of the present invention. Page A1 602 contains links to page B1 604 and page B2 606. Page B1 604 contains links to page C1 608 and page C2 610. The pages are not necessarily from the same server. For example, page A1, page B1, and page B2 may all come from different servers or domains. A user may begin by loading page A1 602. The user may then wish to locate page B2 606 or an item on page B2. The link highlighting mechanism may then highlight the link to page B2 when presenting page A1.

Alternatively, the user may wish to locate page C2 610 or an item in page C2. The link highlighting mechanism may then examine the links to page B1 604 and page B2 606 when presenting page A1. The link highlighting mechanism may also retrieve page B1 and page B2 and examine the links in each of these pages. In a preferred embodiment of the present invention, the number of levels of links followed from the presented page or the total number of pages retrieved may be predetermined and/or user selectable. Thus, the highlighting mechanism may retrieve page B1 and identify the link to page C2 when presenting page A1. The user may then follow a highlighted link on page A1 to page B1 and subsequently follow a highlighted link on page B1 to arrive at the desired page C2.

In another embodiment of the present invention, the user may repeatedly start at page A1, visit page B1, and then visit page C2. The link highlighting mechanism of the present invention may record this click sequence and highlight the recently used links in page A1 and page B1. In an alternative embodiment, the link highlighting mechanism may record a predetermined number of click sequences starting with page A1 and determine a frequently used link. For example, the link highlighting mechanism may record ten click sequences and the user may select page B1 from page A1 eight out of ten times. The user may also select page C2 from page B1 nine out of ten times. Therefore, if the link highlighting mechanism highlights the frequently used link, page B1 will be highlighted when page A1 is presented, regardless of whether page B1 is the recently used link. Whether the highlighting mechanism highlights the recently used link, the frequently used link, both, or neither may be selectable by the user.

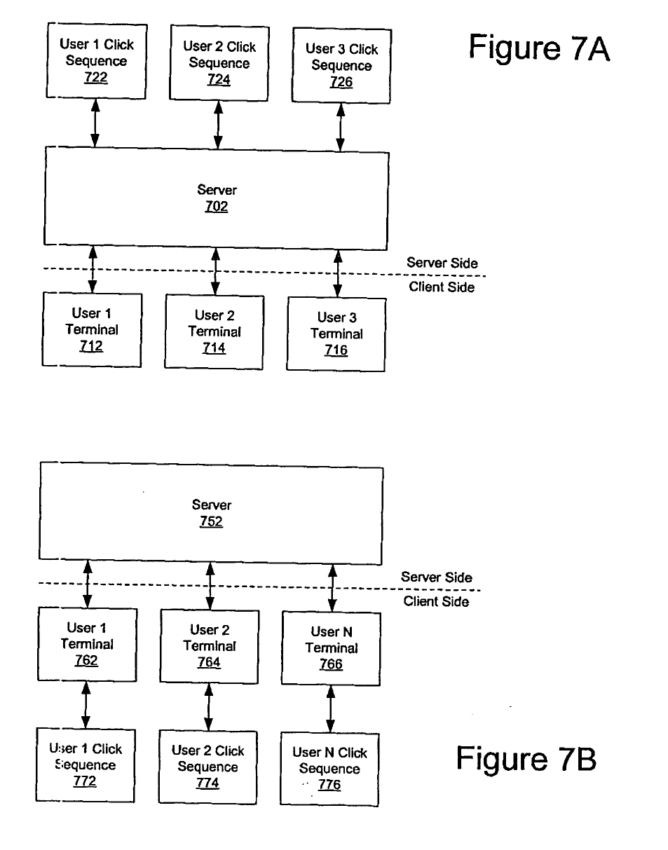

With reference now to FIGS. 7A and 7B, block diagrams illustrating example network arrangements are shown in accordance with a preferred embodiment of the present invention. Particularly, with respect to FIG. 7A, server 702 provides highlighted web content to user 1 terminal 712, user 2 terminal 714, and user 3 terminal 716. Server 702 may be a proxy server that modifies content coming from web servers or may be a specialized web server employing the link highlighting mechanism of the present invention. For example, server 702 may be a web server that provides customized content for users of mobile devices.

In the example shown in FIG. 7A, user 1 click sequence 722, user 2 click sequence 724, and user 3 click sequence 726 are stored at the server side. When a user requests a document from a user terminal, the server may then use the click sequences to determine the recently used links and/or frequently used links. Then, the server may highlight the links in the document appropriately.

Turning now to FIG. 7B, another example is shown in which the user click sequences are stored at the client side. Server 752 provides web content to user 1 terminal 762, user 2 terminal 764, and user 3 terminal 766. The user terminals may execute web browser software that uses the highlighting mechanism of the present invention. The link highlighting mechanism may then use the user click sequences to determine the recently used links and/or frequently used links. Then, the browser software may highlight the links in the document appropriately.

In an alternative embodiment, server 752 may be a proxy server that modifies content coming from web servers or may be a specialized web server employing the link highlighting mechanism of the present invention as in FIG. 7A. However, the user terminals must transfer the user click sequences to allow the server to provide highlighted content.

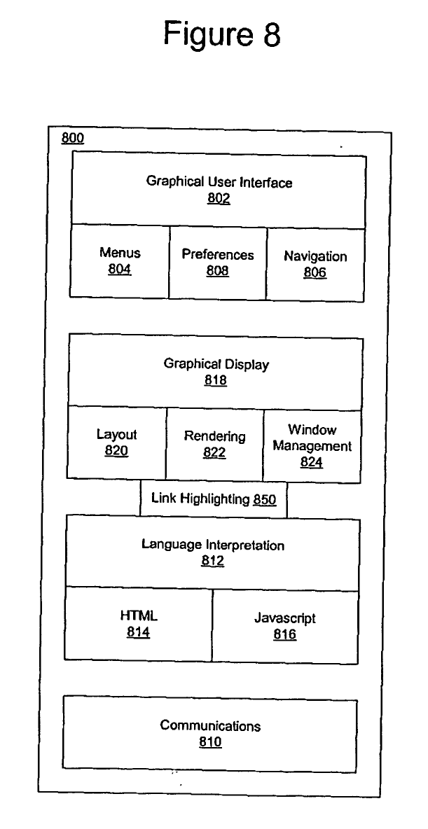

With reference to FIG. 8, a block diagram of a browser program is depicted in accordance with a preferred embodiment of the present invention. A browser is an application used to navigate or view information or data in a distributed database, such as the Internet or the World Wide Web.

In this example, browser 800 includes a user interface 802, which is a graphical user interface (GUI) that allows the user to interface or communicate with browser 800. This interface provides for selection of various functions through menus 804 and allows for navigation through navigation 806. For example, menu 804 may allow a user to perform various functions, such as saving a file, opening a new window, displaying a history, and entering a URL. Navigation 806 allows for a user to navigate various pages and to select web sites for viewing. For example, navigation 806 may allow a user to see a previous page or a subsequent page relative to the present page. Preferences such as those illustrated in FIG. 8 may be set through preferences 808.

Communications 810 is the mechanism with which browser 800 receives documents and other resources from a network such as the Internet. Further, communications 810 is used to send or upload documents and resources onto a network. In the depicted example, communication 810 uses HTTP. Other protocols may be used depending on the implementation. Documents that are received by browser 800 are processed by language interpretation 812, which includes an HTML unit 814 and a JavaScript unit 816. Language interpretation 812 will process a document for presentation on graphical display 818. In particular, HTML statements are processed by HTML unit 814 for presentation while JavaScript statements are processed by JavaScript unit 816.

Graphical display 818 includes layout unit 820, rendering unit 822, and window management 824. These units are involved in presenting web pages to a user based on results from language interpretation 812.

Browser 800 also includes link highlighting 850. The link highlighting allows the browser program itself to locate and highlight items of interest. Link highlighting 850 may communicate with language interpretation 812 to identify the links and with graphical display to modify the layout to highlight the links. For example, link highlighting 850 may instruct graphical display to present the items of interest, such as specific links or a recently used and/or frequently used link, in a separate frame within display area.

Browser 800 is presented as an example of a browser program in which the present invention may be embodied. Browser 800 is not meant to imply architectural limitations to the present invention. Presently available browsers may include additional functions not shown or may omit functions shown in browser 800. A browser may be any application that is used to search for and display content on a distributed data processing system. Browser 800 make be implemented using know browser applications, such Netscape Navigator or Microsoft Internet Explorer. Netscape Navigator is available from Netscape Communications Corporation while Microsoft Internet Explorer is available from Microsoft Corporation.

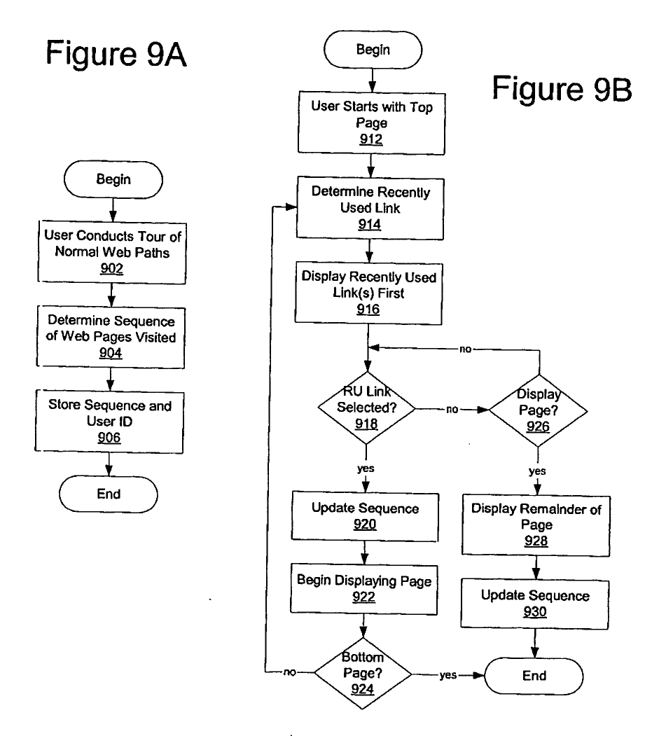

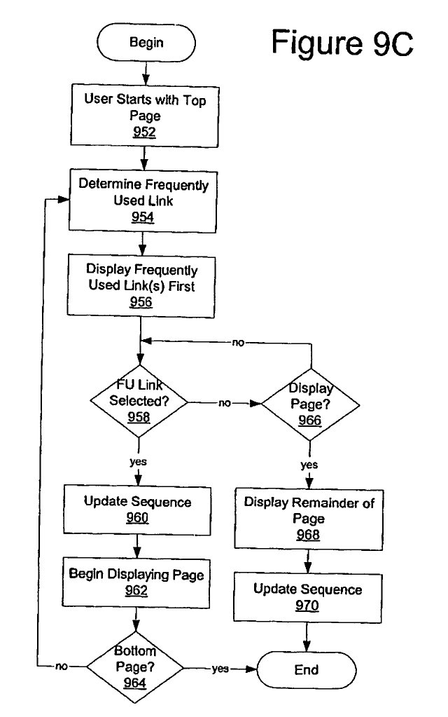

Turning next to FIGS. 9A-9C, flowcharts illustrating a process of highlighting recently used and frequently used links are shown in accordance with a preferred embodiment of the present invention. Particularly, with respect to FIG. 9A, the process begins and the user conducts a tour of normal web paths (step 902). The process then determines a sequence of web pages visited (step 904) and stores the sequence in association with a user identification (ID) (step 906). Thereafter, the process ends.

With reference to FIG. 9B, a flowchart is shown depicting a process of navigating recently used links. The process begins and the user starts with the top page in a hierarchy of web pages (step 912). Next, the process determines the recently used link from the sequence of visited web pages (step 914) and displays the recently used links first (step 916).

Thereafter, a determination is made as to whether the recently used link is selected (step 918). If the recently used link is selected, the process updates the sequence of web pages visited (step 920), and begins displaying the page (step 922). Next, a determination is made as to whether the page is the last page in the hierarchy (step 924). If the page is the last page in the hierarchy, the process ends. However, if the page is not the last page in the hierarchy, the process returns to step 914 to determine the recently used link for the selected page.

If the recently used link is not selected in step 918, a determination is made as to whether to display the page (step 926). The page may be displayed if the user selects a link to request the page. The client may also begin downloading the page while the user is deciding whether to select the recently used link. In this example, the process may determine to display the page if it finishes downloading before a selection is made by the user. As a further example, the page may be displayed if the user preferences indicate that the page is to be displayed.

If the page is not to be displayed in step 926, the process returns to step 918 to determine whether the recently used link is selected. On the other hand, if the page is to be displayed, the process displays the remainder of the page (step 928), highlighting the recently used links if necessary, and updates the sequence of web pages visited (step 930). Thereafter, the process ends.

Turning now to FIG. 9B, a flowchart illustrating a process of highlighting frequently used links is shown in accordance with a preferred embodiment of the present invention. The process begins and the user starts with the top page in a hierarchy of web pages (step 952). Next, the process determines the frequently used links from the sequence of visited web pages (step 954) and displays the frequently used links first (step 956).

The process may determine the frequently used link by storing all or a predetermined number of click sequences. The most frequently used link may simply be the link with the highest percentage of visits. The process may also determine a predetermined number, such as two for instance, of the most frequently used links.

Thereafter, a determination is made as to whether a frequently used link is selected (step 958). If a frequently used link is selected, the process updates the sequence of web pages visited (step 960), and begins displaying the page (step 962). Next, a determination is made as to whether the page is the last page in the hierarchy (step 964). If the page is the last page in the hierarchy, the process ends. However, if the page is not the last page in the hierarchy, the process returns to step 954 to determine the frequently used links for the selected page.

If a frequently used link is not selected in step 958, a determination is made as to whether to display the page (step 966). The page may be displayed if the user selects a link to request the page. The client may also begin downloading the page while the user is deciding whether to select a frequently used link. In this example, the process may determine to display the page if it finishes downloading before a selection is made by the user. As a further example, the page may be displayed if the user preferences indicate that the page is to be displayed.

If the page is not to be displayed in step 966, the process returns to step 958 to determine whether a frequently used link is selected. On the other hand, if the page is to be displayed, the process displays the remainder of the page (step 968), highlighting the frequently used links if necessary, and updates the sequence of web pages visited (step 970). Thereafter, the process ends.

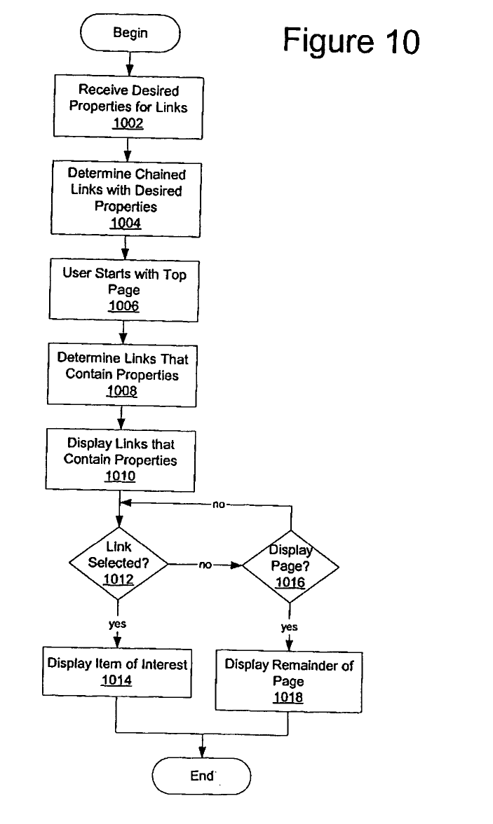

With reference to FIG. 10, a flowchart illustrating a process of highlighting items of interest is shown in accordance with a preferred embodiment of the present invention. The process begins and receives desired properties for links (step 1002). The process then determines chained links with the desired properties (step 1004) and the user starts with the top page in a hierarchy of web pages (step 1006). Then, the process determines links that contain the properties (step 1008) and displays links that contain the properties (step 1010).

Thereafter, a determination is made as to whether a link is selected (step 1012). If a link is selected, the process displays the item of interest (step 1014) and ends. If a link is not selected in step 1012, a determination is made as to whether to display the page (step 1016). If the page is not to be displayed, the process returns to step 1012 to determine whether a link is selected. On the other hand, if the page is to be displayed in step 1016, the process displays the remainder of the page (step 1018), highlighting the items of interest if necessary. Thereafter, the process ends.

Thus, the present invention solves the disadvantages of the prior art by providing a mechanism for highlighting items of interest in a set of web pages. The link highlighting mechanism may retrieve and examine web pages referenced by the instant web page. In this manner, the link highlighting mechanism may crawl through a set of web pages and highlight links that direct the user to the item of interest. The link highlighting mechanism may also record a user's click sequence to determine the most recently or most frequently visited links. The mechanism may then highlight the most recently or most frequently visited links to allow easy and quick navigation to items that are of particular interest to the user. The user may also enter properties of an item of interest, such as a file type or link type. For example, a user may be looking for an image, sound, or e-mail address. The link highlighting mechanism of the present invention examines a web page for items and links that match the property.

When a user needs to locate a link quickly, the highlighting mechanism automatically highlights and scrolls to the desired link. When a typical page is displayed on a palmtop computer, the text size may be too small to read easily and/or the page size may be too large to display without scrolling. The highlighting mechanism may also reside on a server, such as a proxy server. Thus, the server may send a modified page comprising only the items of interest rather than sending the whole page. Therefore, the highlighting mechanism of the present invention is particularly useful when displaying pages on a handheld mobile computer where screen space may be limited and low bandwidth may make downloading of pages time consuming and cumbersome.

The highlighting mechanism of the present invention may also be expanded to other interfaces. For example, a user may routinely operate a handheld computer to run a spreadsheet program, select open, and select an expense spreadsheet. Thus, upon turning on the handheld computer, the highlighting mechanism of the present invention may present the user with a link to the spreadsheet program. If the link to the spreadsheet program is selected, the highlighting mechanism may present a link to the open command. And if the link to the open command is selected, the highlighting mechanism may present a link to the expense spreadsheet file.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1-20. (canceled)

21. A method for highlighting links of interest in a web document, comprising:
receiving at least one property for an item of interest;
retrieving a web document;
identifying a link in the web document that satisfies the at least one property;
presenting the web document; and
highlighting the at least one link in the web document.

22. The method of claim 21, wherein the step of identifying a link in the web document comprises:
retrieving a referenced document corresponding to a first link in the web document; and
identifying a link in the referenced document that satisfies the at least one property.

23. The method of claim 22, wherein the at least one property comprises a file type.

24. The method of claim 23, wherein the file type comprises one of an image file and a sound file.

25. The method of claim 21, wherein the at least one property comprises a link type.

26-45. (canceled)

46. An apparatus for highlighting links of interest in a web document, comprising:
receipt means for receiving at least one property for an item of interest;
retrieval means for retrieving a web document;
identification means for identifying a link in the web document that satisfies the at least one property;
presentation means for presenting the web document; and
highlight means for highlighting the at least one link in the web document.

47. The apparatus of claim 46, wherein the identification means comprises:
means for retrieving a referenced document corresponding to a first link in the web document; and
means for identifying a link in the referenced document that satisfies the at least one property.

48. The apparatus of claim 46, wherein the at least one property comprises a file type.

49. The apparatus of claim 48, wherein the file type comprises one of an image file and a sound file.

50. The apparatus of claim 46, wherein the at least one property comprises a link type.

51-52. (canceled)

53. A computer program product, in a computer readable medium, for highlighting links of interest in a web document, comprising:
instructions for receiving at least one property for an item of interest;
instructions for retrieving a web document;
instructions for identifying a link in the web document that satisfies the at least one property;
instructions for presenting the web document; and
instructions for highlighting the at least one link in the web document.
